(19) United States
(12) Patent Application Publication
(10) Pub. No.: US 2018/0037010 A1
(43) Pub. Date: Feb. 8, 2018

(54) Composite Film

(71) Applicant: Constantia Teich GmbH, Weinburg (AT)

(72) Inventors: Lambert Nekula, Hofstetten (AT); Martin Kornfeld, Klosterneuburg (AT); Adolf Schedl, Lilienfeld (AT); Harald Gruber, Amstetten (AT)

(21) Appl. No.: 15/555,387

(22) PCT Filed: Aug. 24, 2015
(86) PCT No.: PCT/EP2015/069365

§ 371 Date: Sep. 1, 2017

(30) Foreign Application Priority Data
Mar. 4, 2015 (EP) 15157605.5

(51) Int. Cl. B32B 21/06; B32B 19/04; B32B 21/08; B32B 27/08; B32B 27/10; B32B 27/12; B32B 27/28; B32B 27/30; B32B 27/32; B32B 27/34; B32B 27/36; B32B 29/04; B32B 3/02; B32B 3/16; B32B 5/02; B32B 5/24; B32B 7/02; B32B 7/12; B32B 15/08

(52) U.S. Cl. CPC B32B 21/06; B32B 15/08; B32B 19/04; B32B 21/08; B32B 27/08; B32B 27/10; B32B 27/12; B32B 27/28; B32B 27/30; B32B 27/32; B32B 27/34; B32B 27/36; B32B 29/04; B32B 3/02; B32B 3/16; B32B 5/02; B32B 5/24; B32B 7/02; B32B 7/12; B32B 2262/0276; B32B 2264/102; B32B 2307/7244; B32B 2307/7246; B32B 2307/7248; B32B 2307/75; B32B 2439/70

(57) ABSTRACT

A composite film including at least one backing film made of a backing material, at least one barrier layer made of a barrier film and at least one laminating adhesive layer therebetween. On the side of the barrier layer away from the backing layer, the composite film has a raised pattern, and in the area of the raised pattern, the barrier layer has stretched stretching regions relative to the non-stretched barrier film. In the area of the raised pattern, the barrier layer has on the side facing the backing layer surfaces that are not joined to the backing layer.

### TECHNICAL FIELD

The invention relates to a composite film having at least one backing layer made of a backing material, at least one barrier layer made of a barrier film and at least one laminating adhesive layer in between as well as a method for producing this composite film. In addition, the invention relates to a device for producing such a composite film, wherein the device has a backing material feed, a laminating adhesive application, a barrier film feed and a press device, wherein at least the backing layer, the laminating adhesive layer and the barrier film are pressed at least partially against one another by the press device to laminate them. The invention also relates to a method for producing such a composite film.

### BACKGROUND

Composite films of this type are used in many areas of application. The backing layer may be made of paper, for example, or some other porous or not moisture resistant material that receives its sealing properties from the barrier layer. Alternatively, the backing layer itself may also have barrier properties, as may be the case with coated metal foils, for example, in particular aluminum foil, which has barrier properties itself and is additionally coated with a barrier material. In this case, it is not necessary for the barrier layer itself to have barrier properties. In conjunction with the present description, the terms “backing layer,” “backing material,” “barrier layer” and “barrier film” are used only for the purpose of comprehensibility and differentiability and, inasmuch as this is not stated explicitly, are not to be interpreted in a restrictive sense or as an indication of certain inherent properties.

In conjunction with the present description, the terms “backing material,” “barrier film” and “laminated adhesive” are used to identify the starting material of which the layers of the composite film are composed. The terms “backing layer,” “barrier layer” and “laminating adhesive layer” in general refer to a layer of the corresponding materials which is already part of a composite film or is being processed to such a film. However, the differentiation in terms between backing material and backing layer, barrier layer and barrier film and/or laminating adhesive layer and laminating adhesive is used only to facilitate an understanding, and this differentiation is not to be interpreted restrictively.

The barrier film usually consists of a plastic material, wherein polyester, for example, is preferred for use in many cases because of its good processability, imperviousness and safety for use with food. The barrier film is usually laminated onto the paper, so that drive laminating adhesives, wet laminating adhesives, extrusion laminating adhesives or solvent-free adhesive systems may be used here.

For numerous applications, the composite film is punched or cut after being produced, for example, for the production of lids which are used as covers for containers in particular for finished packaging in the food field. Due to the use of composite films, for example, it is possible to produce lightweight and inexpensive lids which can at least replace the aluminum lids that have previously been used. Metal-free lids also allow the use of metal detectors for quality control and safety control of sealed packages. If necessary the composite films may additionally have a metal layer, in particular an aluminum foil layer, to improve the barrier properties, but in many cases this is not necessary.

The term “lid” as used in conjunction with the present description identifies a cover element punched out of a film material and used for sealing a container. The lid can be fixedly joined to the container, for example, with the help of a sealing layer or may be embodied as an add-on layer, wherein the hold of the lid on the container can be secured by means of an additional element or in a form-fitting manner, for example, by folding over the edges of the lid.

Composite films coated on one side (and asymmetrical composites in general) have proven to be a disadvantage or to be completely unusable as a lid material because the lids may warp or curl after being punched out and/or cut out due to the difference in the properties of the material of the backing material and the barrier layer. This is referred to as warping or “curling.” Such curling occurs in particular when the backing layer contracts more than the barrier layer after lamination, which may be the case in particular with a backing layer made of paper. The extent of this curling is influenced by many factors. In the case of a paper/plastic composite, the moisture content of the paper layer is an important influencing factor. With other composite materials, for example, with an aluminum/plastic composite, temperature differences and internal stresses with the materials used in particular may cause curling. The greater the difference in the physical properties of the materials used, the more difficult it is to combat the problems associated with curling.

To prevent curling, the composite films may be embodied with a symmetrical layer profile, for example, by applying an identical barrier layer to both sides of the backing material. This increases not only the cost of materials but also the cost of the production facilities because the step of lamination must be carried out twice.

After being punched out and/or cut out, lids are stacked and sent to a separating device for further processing. This separating device lifts the top lid with the help of a suction mechanism in the usual manner and places it on the package to be sealed where it is generally sealed to the package with a sealing tool. First, the top lid can be lifted only if the lids in the stack are not warped but instead are flat; second, in particular when working with very smooth lids, for example, lids that have been coated on both sides, the unwanted effect occurs that the top lid adheres to the lid beneath it because of the resulting vacuum, so that two or more lids are lifted at the same time by the suction mechanism. In the technical field, this problem is referred to as the “pane of glass effect.” To prevent this, it is known that with traditional lids, spacer elements such as elevated dots or patterns are provided on one side of the lid, for example, on the unprinted side or the lid may be provided with embossed patterns to prevent the lids from sticking to one another.

The problem of lids adhering to one another is even greater as the lids become lighter and thinner. It is nevertheless desirable from the standpoint of environmental safety and logistics to design the lids to be as thin and lightweight as possible.

### SUMMARY

One goal of the present invention is to create a composite film of the type defined in the introduction, which need not necessarily be coated symmetrically on both sides and nevertheless avoids the disadvantages of the prior art.

These and additional goals are achieved by a composite film of the type defined in the introduction in which the composite film has an elevated pattern on the side of the barrier layer facing away from the backing layer wherein in the area of the elevated pattern the barrier layer has stretched regions that have been stretched relative to the unstretched barrier film and wherein in the area of the elevated pattern the barrier layer has surfaces on the side facing the backing layer that are not bonded to the backing layer. These elevated patterns thus form spacers, which prevent the layers from adhering to one another during the separation process. In addition to this functionality, a haptic/visual decorative layer is created by specifying a pattern with which the stretched regions are introduced into the barrier layer. The sliding properties can also be influenced by the elevated areas, for example, by forming elongated “sliding tracks” on the composite material to preselect a sliding direction. Such sliding tracks may be provided on the inside of bag packages, for example, in order to make it easier to pour the contents. On the other hand, the elevated pattern can also impart anti-slip properties to the composite material on the barrier layer side.

The phrase “surfaces not bonded to the backing layer” refers to regions of surfaces where there is little or no adhesive effect with respect to the backing layer. This is the case in particular with surfaces which do not come in contact with the laminating layer and are in contact with another surface region of the same barrier layer (i.e., the surfaces are in contact on the inside of a fold) or in the case of surfaces which are in contact with the laminating adhesive but in which the laminating adhesive has little or no adhesive effect with respect to the backing layer. This may the case, for example, when laminating adhesive is present between the surfaces of the barrier layer in contact with one another on the inside of a fold but it does not produce any adhesion of the surfaces to the backing layer. Surfaces not bonded to the backing layer in general form areas that are lifted up from the surface of the backing layer, such that the surfaces of the barrier layer facing the backing layer in these regions do not generally run parallel to the surface of the backing layer.

The term “elevated” in this context with the present description refers to the “normal” surface of a flat composite film, i.e., a composite film whose thickness corresponds to the total thickness of the individual layers. In conjunction with the present description, a “elevated pattern” is regarded as being a regular or irregular pattern in the area of which the surface has an elevation in comparison with the “normal” surface.

In a preferred embodiment, the surfaces which are on the side of the barrier layer, which is facing the backing layer, and which are not bonded to the backing layer, are at least partially in contact with one another. This minimizes the volume of cavities between the backing layer and the barrier layer.

In an advantageous manner the elevated pattern may correspond to a stretch pattern of stretched regions. This allows simple production of the composite film with a well-defined elevated pattern. The “stretch pattern” in conjunction with the present disclosure of the invention refers to the totality of regions of the barrier film in which the barrier film has a stretch that has been imparted intentionally in comparison with the unstretched barrier film, for example, with the help of embossing rollers or vacuum rollers.

In another advantageous embodiment, the stretched regions may form stress equalization zones which equalize stretching-induced stresses between the layers. These stress equalization zones may be designed according to the invention as folds or lifted areas of the barrier film running along the composite film and in this case running along the stretch pattern. The folds or lifted areas are able to stretch or contract with any change in area ratios between the backing layer and the barrier layer, for example, due to environmental factors such as humidity and/or temperature, and thereby compensate for the resulting stresses. Therefore, the occurrence of curling is also effectively prevented, even under variable weather conditions, and it is possible to punch lids out of a very thin composite film. Hollow spaces and/or cavities that may exist between the barrier layer and the backing film are minimized by such folds, and a defined elevated pattern can be created easily on the surface of the lid on one or both sides of the barrier layer.

The term “lifted” is used to refer to an area in which the barrier film is not bonded to the laminating layer, i.e., it is lifted up away from it.

The stretch pattern may be a regular or irregular pattern, so that a visually attractive design is possible. The stretch pattern may be embodied as a number of parallel lines or double lines, for example. On the other hand, graphical patterns or a simple or regularly repeating logo or trademark may also form the stretch pattern.

The inventors have found in experiments that it is possible to produce composite films, in which the elevated patterns surprisingly differ substantially from the stretch patterns produced in the barrier film, and assume shapes that also extend between the regions of the stretch pattern. Therefore, the elevated pattern can differ at least partially from the stretch pattern in an advantageous manner. Corresponding methods and devices for producing such composite films are also described in greater detail below.

The elevated pattern may advantageously be a reticulated pattern. The structures of the reticulated pattern generally extend between regions of the stretch pattern, for example, from a round closed stretched region to a round closed stretched region arranged at a distance from the former. The structure of such a pattern, which has elevations in the form of a network, covers the entire surface of the composite film, so that the film does not form excessively thick regions when wound up to form a roll, and uniform winding is ensured over the entire surface of the roll. The same effect also occurs with lids punched out of the composite film. This improves the behavior of the lids when they are being separated.

The elevated pattern on the surface of the composite film may advantageously have an excess thickness h where the ratio h/d of the excess thickness h to the total thickness d of the individual material layers in the composite film is less than 10 and preferably less than 5 and in particular has a value of approx. 0.05 to 2, for example, approx. 0.1 to 2. The “total thickness d” is understood to refer to the thickness of the individual materials contained in the composite film without taking into account the stretching and without any empty interspaces. The thickness d can be measured, for example, as the thickness of the composite film in the regions outside of the stretched regions. The extra thickness h is regarded as the distance between the thickness d and the maximum thickness of the composite film in the stretched regions (including any cavities). The total thickness d of the composite film may be, for example, between 11 μm and 230 μm, preferably between 14 μm and 140 μm, depending on the requirements and the combination of materials.

In another advantageous embodiment, the backing layer may be covered with the laminating adhesive layer over its full area. A full area lamination facilitates the production process. Alternatively, a partial lamination, i.e., not continuous may also be provided, wherein the lamination may be eliminated, for example, in the stretched regions or in parts thereof.

In another advantageous embodiment, the composite film may have a covering layer. The covering layer may be an additional sealing layer, for example, which is applied to the composite film on the barrier layer side, for example, when the material of the barrier film itself is not sealable. The inventors have discovered that surprisingly the barrier layer having the stress equalization zones provided therein and being beneath the covering layer effectively prevents curling of the composite film, even when the covering layer above it forms a continuous layer. This is the case even if the same composite film with the covering layer but without the barrier layer (and/or with a barrier layer but without the stress equalization zones) would result in very severe curling effects.

The backing layer may advantageously be printed on the side facing the barrier layer and/or away from the barrier layer. In the case of a transparent, translucent or light-permeable barrier layer, bonding of the print pattern and the pattern of stress equalization zones can be achieved by printing on one or both sides of the barrier layer. Then a coloration or a separate pattern of the barrier layer may be taken into account for the overall impression of the finished surface. The smooth and high quality side of the backing material is preferably used as the side facing away from the barrier layer in order to obtain a good print image on the outside of the lid which is visible to the consumer. Numerous design and effect possibilities can be achieved with such a combination.

In addition, it is also possible to print on the barrier layer. For example, a mirror printing may be applied to the side of the barrier layer facing the backing layer.

According to the invention the backing material may be selected from a fiber material such as paper or cardboard, in particular paper or recycled paper with a thickness between 20 μm and 150 μm, preferably between 40 μm and 90 μm, a metal foil, for example, aluminum foil with a thickness between 5 μm and 40 μm, preferably between 8 μm and 25 μm or a plastic material such as polyester or some other plastics, for example, the plastics that can be used for the barrier film. The plastic material may have a thickness of 5 to 50 μm, for example, preferably between 12 and 30 μm. A thickness of approx. 23 μm is especially preferred. The invention can fundamentally be applied to any composite films in which curling effects can occur.

The barrier film may have a thickness of approx. 5 to 80 μm, for example, preferably of 6 to 50 μm. The material of the barrier film may preferably be selected from polyesters such as polyethylene terephthalate (PET), wherein the polyester film may be provided with an additional surface treatment in the form of a metallization or some other inorganic layer, for example, SiOx or AlOx or an adhesion-promoting layer (primer) for application of a sealing layer. Further the barrier film may be based on polyamides, for example, PA 6 or PA 12 or other materials of this group. Polyolefins, for example, polyethylene (PE) may also be used as the barrier film, and different types of PE can be produced here (LDPE, HDPE, etc.), which can be produced by using Ziegler-Natta catalysts or metallocene catalysts, for example, ethylene copolymers (EVA, EMA, etc.) or blends of these plastics, polypropylene (PP) and PP copolymers or other thermoplastic polyolefins. Suitable barrier films for use here also include films of biopolymers based on renewable raw materials, for example, starch polymers, polylactic acid (PLA), polymers based on lignin, polyhydroxyalkanoates (PHAs), etc., corresponding blends or compounds, biodegradable/compostable raw materials, for example, special biopolyesters (e.g., Ecoflex), etc. The barrier film may be a monofilm, which may be undrawn (for example, cast PP) or may also be oriented (for example, OPA, OPP). The barrier film may also be a coextruded multilayer film, for example, a polyethylene film with an additional barrier layer of EVOH or a film with specially designed sealing layers or peel layers.

Other materials with which those skilled in the art are familiar may also be used as the barrier film and the respective choice may be based on the desired properties of the material. For example, films made of metal, e.g., aluminum foils, made of paper or other fabric materials may be used as the barrier film or contained therein.

The barrier layer may be made of a single material or it may consist of multiple layers of different materials. Multilayer barrier layers may be extrusion-coated films, for example, or the barrier layer may be a film coextruded with multiple materials in order to combine advantageous properties of different extrudable materials and/or to influence the surface properties of the film through the outer layer selected respectively.

Examples of multilayer films and optionally coextruded films include films made of a main material which is provided with a coating and/or multiple coatings on one or both surfaces. A primer layer, an adhesive layer or a glue layer may be provided between the main material and the coating. The main material may be selected, for example, from the materials listed above as examples of barrier films, or it may also consist of multiple layers of these materials, each with or without intermediate layers (e.g., adhesive, primer or glue layer). The coating may in turn consist of multiple layers. Thus, for example, a coextrusion coating of different coating materials may be applied to a layer of a main material. The main material may be provided on either one or both sides with the same coatings or with different coatings.

For example, a sealing film or a peeling film or a hot seal lacquer (HSL) may be applied to the main material either adhering directly or with a primer layer or adhesive layer. The coating material and/or the main material may additionally be provided with a light protection layer, e.g., metallization.

The laminating adhesive may be selected from wet lamination adhesives or dispersion adhesives such as LANDOCOLL 7170 from Svenska Lim; dry lamination adhesives such as ADCOTE™ 545 or CATALYST F from Rohm and Haas or Liofol UK 3646 or UK 6800 from Henkel; from solvent-free adhesive systems, from cold seal adhesives such as Crodaseal 22-121 from Croda Adhesives or from an extrusion-coated lamination. Methods of extrusion lamination may also be used to perform the lamination.

One example of an advantageous composite material for producing lids is a paper/dry laminating adhesive/polyester composite, where polyester acts as a barrier layer. Polyester has the advantage of a high puncture resistance and is therefore especially suitable as a barrier layer for lids. The high puncture resistance allows safe stacking of a plurality of containers sealed with the lid, where the lid is loaded by the weight of the containers stacked over it, as may be the case, for example, with containers of yogurt. In particular when being transported by customers, for example, in a shopping cart or a shopping bag, the lids may be damaged by pointed or sharp-edged objects being transported at the same time. A very good puncture resistance will prevent this. Since polyester is not readily sealable, the polyester layer may have a sealing film on the side away from the paper. Therefore it is not necessary to apply an additional sealing layer to the barrier layer (provided with stress equalization zones) after lamination. The polyester layer and the sealing layer may be produced as a coextruded film as explained above. The paper may preferably be printed on the coated side, i.e., on the smooth high-quality side, while the barrier layer may be applied to the rough layer on the opposite side.

Another advantageous combination of materials is paper/solvent-free laminating adhesive/PLA. This composite film is highly biodegradable. When environmentally safe inks such as water-based inks are used for printing, this makes it possible to produce lids that are almost completely biodegradable.

The present invention additionally relates to the use of a composite film according to the invention for producing a lid for closing containers. In addition, the invention relates to lids produced from the composite film. Such lids are thinner and lighter than traditional lids with a symmetrical layer profile, and they can be manufactured in such a way that no curling effects occur with changing environmental conditions. This ensures secure and reliable separation. As explained above, these lids may optionally be biodegradable. The containers are preferably sealed in such a way that the barrier layer of the lid faces the contents of the container. In other cases, however, the container may also be sealed with the backing layer, in which case the side of the barrier layer would then form the outer surface.

In a preferred embodiment the lid may have a sealing region on the barrier layer side and/or on the backing layer side for sealing the lid onto the container. Depending on the specific application, the side of the barrier layer and the stretched regions present therein may thus be provided for the side facing the packaging (and the product packaged therein) or for the “front side” facing the customer.

In another aspect, the invention relates to a device of the type defined in the introduction, in which, according to the invention, between the barrier film feed and the pressing device a stretching entity is provided for introducing a stretch pattern of stretched regions that have been stretched into the barrier film. The stretching entity can be integrated easily into known devices for manufacturing composite films.

In an advantageous embodiment, the stretching entity may be formed by the intermeshing profiles of a positive profile roller and a negative profile roller, between which the barrier film is passed. With this device, the stretched regions can be introduced into the barrier film easily and with patterns that can be varied in a variety of ways. The depth of penetration of the profiles, i.e., the distance between the positive profile roll and the negative profile roll can preferably be adjusted. The depth of penetration is an important process parameter in order to be able to adapt the production process to different material properties. When using the device according to the invention, it may have happen in particular in the edge regions of the profile rollers that material from the edge of the barrier film passing between the positive profile roller and the negative profile roller is “pulled into” the profiles. However, the resulting reduction in the width of the barrier film tends to be minor and can be taken into account easily as an operating parameter.

Another advantageous embodiment may provide that the press device is designed as a pressing roller that presses against the negative profile roller, between which the material to be pressed to form the composite film is passed. The device therefore has compact dimensions because the negative profile roller, on the one hand, is used as part of the stretching entity and, on the other hand, is used as part of the press device. It is therefore possible to ensure that the lamination is carried out immediately after introducing the stretched regions. On the other hand, it is possible to ensure that the width of the barrier film resting on the negative profile roller and having stretched regions introduced into it will not be undergoing changes between the step of stretching in the stretching entity and lamination in the press device. This ensures that the stretched regions will have the excess material required to form the stress equalization zones in lamination. The profiles of the negative profile roller serve as recesses in which the stretched regions are accommodated, while the barrier film is laminated to the backing material at the other locations. Therefore, the barrier film is not pressed against the backing material in the regions of the negative profiles but instead can form the elevated pattern in this region.

The shape of the profiles created in the profile roller, the material processes and the pressure settings of the press device and the stretching entity determine how the stretched regions will “fold” after lamination in order to form elevations, spacers and/or stress equalization zones. If necessary, the stretched regions may be formed selectively on the laminating layer after lamination by means of separate devices, for example, additional profile rollers that are pressed selectively against the lamination layer in order to achieve a certain pattern of folds. However, by means of a suitable selection of parameters, the desired fold shape can also be achieved in most cases, even without such an additional device. Since the stretched regions have a greater surface area than the surface area of the backing material opposite them, surfaces may be formed in the side of the barrier layer facing the backing material, such that these surfaces are not bonded to the backing material and may be at least partially in contact with one another when a fold is formed in the stretched region.

In experiments with different embodiments of the device according to the invention, the inventors have surprisingly discovered that the elevated pattern is sometimes not formed in the locations of the stretch pattern but also in adjacent surface regions, where no stretched regions have actually been created in the barrier film. Then depending on the combinations of materials, the processing rates and the extent of stretching, various elevated patterns are formed and can be optimized accordingly by those skilled in the art through routine measures and experiments. The type of pattern that develops in this case can be regulated in particular with the help of the adjustment of the infeed of the pair of rollers comprised of a positive profile roller and a negative profile roller.

For these purposes a particularly advantageous embodiment of the pair of rollers has been developed in which the positive profile roller has a regular or irregular arrangement of elevated embossing pins and the negative profile roller has corresponding recesses with which the embossing pins engage. With this embodiment a particularly uniform reticulated pattern can be created with the connecting lines of the reticulated pattern thereby created extending between the stretched regions formed in the barrier film by the embossing pins.

In another aspect, the invention relates to a method for producing a composite film having at least one backing layer made of a backing material, at least one barrier layer made of a barrier film and at least one laminating adhesive layer in between. Before lamination, a stretch pattern of stretched regions is created in the barrier film, and then the barrier film is laminated as a barrier layer onto the backing layer. A deformation of the barrier film produced due to the stretching and/or a partially elastic recoil after stretching creates an elevated pattern on the composite film, wherein in the area of the elevated pattern the barrier layer has surfaces on the side facing the backing layer that are not bonded to the backing layer. Depending on the embodiment, the elevated pattern thereby obtained may act as a spacer, a haptic pattern and/or a visual pattern and/or as a stress equalization zone.

In one advantageous embodiment, the barrier film may be guided between a positive profile roller and a negative profile roller with intermeshing profiles to create the stretched region.

In an advantageous manner the composite of the backing layer, the laminating adhesive layer and the barrier layer may be pressed between the negative profile roller and a pressing roller.

In one advantageous embodiment, the lamination may take place between a negative profile roller and a pressing roller, wherein the interval of time between embossing and lamination is determined by the radial position of the contact point between the pressing roller and the negative profile roller and the circumferential speed of these rollers.

Depending on the choice of materials and parameters, the elevated pattern may be different from the stretch pattern. The elevated pattern may be formed both in the area of the stretched regions as well as outside of these regions, for example, at connecting lines between two stretched regions that are close together. This makes it possible to create a visually attractive pattern with a regular appearance. The composite film produced in this way can therefore be rolled up onto rolls without the pattern resulting in bulges being further built up from one layer to the next.

The design of the elevated pattern can then be regulated advantageously by adjusting the infeed of the pair of rollers and/or the interval of time between embossing and lamination. The parameters that are optimal for the respective combinations of materials and manufacturing processes can be discovered by those skilled in the art on the basis of routine experiments.

The lamination may advantageously take place while the barrier film undergoes partial elastic recoil after the stretch pattern has been produced. The barrier film therefore assumes its final shape only after being laminated onto the backing layer and may be shifted, drawn and/or displaced slightly on the backing layer to form the elevated pattern.

### BRIEF DESCRIPTION OF THE DRAWINGS

The present invention is explained in greater detail below with reference to FIGS. 1 to 13 which show advantageous embodiments of the invention as examples, schematically and nonrestrictively:

FIGS. 1a and 1b each show a sectional view through a composite film according to the invention with stress equalization zones provided therein;

FIG. 2 shows a sectional view through a composite film according to the invention provided with a covering layer;

FIG. 3 shows a lid in a view from above on the barrier layer side;

FIG. 4 shows a schematic diagram of a device according to the invention for producing the composite film;

FIG. 5 shows a sectional view of the profile rollers along their line of contact according to the sectional line V-V in FIG. 4;

FIG. 6 shows a sectional view of the negative profile roller and the pressing roller along their line of contact according to sectional line VI-VI in FIG. 4;

FIGS. 7a to 7h show exemplary arrangements and patterns of stress equalization zones;

FIGS. 8 through 11 show exemplary embodiments of negative and positive profile rollers; and

FIGS. 12 and 13 show alternative embodiments of the device according to the invention for producing the composite film;

FIGS. 14 to 17 show different lids made of a composite film according to the invention produced using the same pair of rollers.

### DETAILED DESCRIPTION

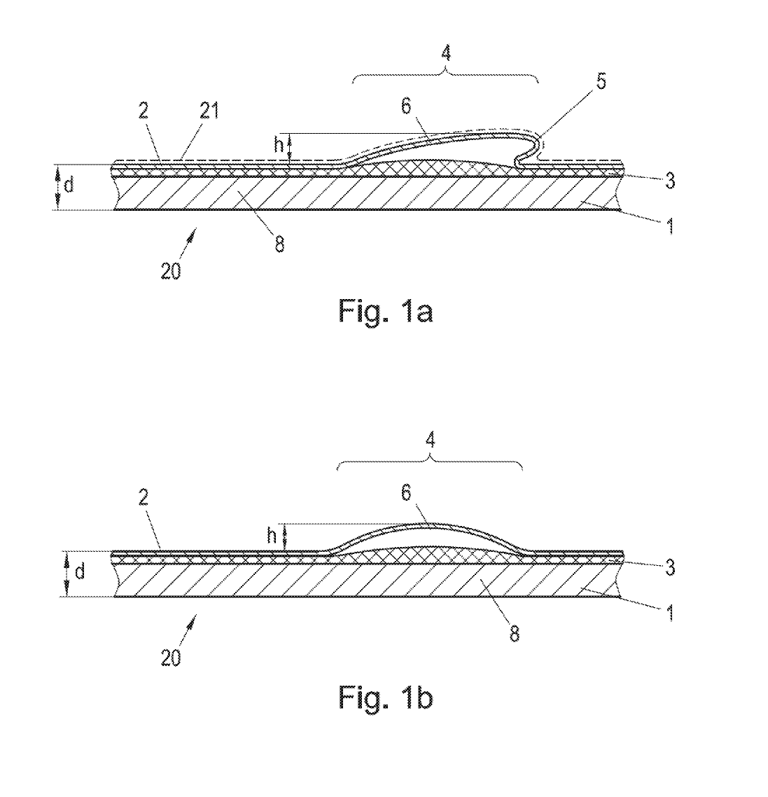

FIGS. 1a and 1b each show a sectional view through the layers of an exemplary composite film 20 according to the invention, wherein the size and width ratios are not drawn to scale.

The composite film 20 illustrated in FIG. 1a has a backing layer 1, on the surface of which a barrier layer 2 is applied with the aid of a laminating adhesive layer 3. A sealing film 21, which is illustrated as a dashed line, may optionally be applied to the outer surface of the barrier layer 2. A stress equalization zone 4, which is embodied as folding 5 of the barrier layer 2, is provided in the barrier layer 2. Beneath the folding 5, there is a cavity in the position illustrated, in which the surface of the barrier layer 2 facing the backing layer 1 is not bonded to the backing layer 1. In the case of the composite film 20 illustrated in FIG. 1, a relatively great stretching was created in the barrier layer 2 in the region of the stress equalization zone, so that the barrier layer 2 is folded toward one side in the stretched region 6, which forms the stress equalization zone 4 and has developed a fold 5. The method for introducing the stretching and the lamination is described in detail further below. The cavity beneath the stretched region 6 may be compressed further when the composite film 20 is rolled up or in a downstream roller configuration, wherein a certain excess thickness h always remains in the region of the stress equalization zone 4 because of the excess material there. When the material of the barrier layer 2 is pressed from the outside against the backing layer in the region of the stress equalization zone 4, for example, when the material is being rolled up and therefore comes in contact with the laminating adhesive layer 3, there remains in general a region in which the surface of the barrier layer 2 facing the backing layer 1 is in contact with the interior of the fold 5 and therefore is not bonded to the backing layer 1. When the backing layer 1 then stretches or contracts due to weather influences, heat or humidity, for example, the folding 5 can equalize this change and prevent stresses that would result in bulges in the composite film 20 occurring in the barrier layer 2 or the backing layer 1. Such bulges would result in curling of lids punched out of the material. The stress equalization zone 4 thus easily prevents differences in stress from developing between the barrier layer 2 and the backing layer 1. Such stresses may occur in particular when the properties of the material of the layers differ greatly as is the case, for example, with paper/plastic films, metal/plastic films or metal/paper composite films.

The sealing film 21 indicated in FIG. 1a serves to bond the lid punched out of the composite film 20 to the container, thereby closing the container with a seal. The sealing film 21 may be applied to the barrier film 9, which forms the barrier layer 2, or may be coextruded with it and may thus be regarded as an integral part of the barrier layer 2, wherein the sealing film 21 follows the course of the barrier layer 3 in the region of the stress equalization zone 4. For sealing the package in a known way, the edge of the lid is pressed against the edge of the package to be sealed using a sealing tool while applying a sealing pressure at a sealing temperature. The usual sealing pressures are then in the range of approx. 2 to 4 bar, usually approx. 3 bar. The sealing temperature may be between 120° C. and 290° C., mostly between 180° C. and 250° C., for example, with traditional sealing films. In the area of the stress equalization zones 4, where the fold 5 causes a change in thickness of the composite film 20, the seal is ensured by elastic deformation of the layers, in particular the barrier layer 2. Beneath the fold 5, the outer surfaces of the sealing film 21 are in contact with one another, which ensures the tightness of the seal in this area. During the sealing operation, any cavities and channels that remain between the barrier layer 2 and the backing layer 1 are closed and welded tightly in the sealing area. Since the sealing area is generally provided around the entire periphery of the lid, the channels are sealed hermetically from all sides. Any channels optionally remaining in the interior of the surface of the lid are thus sealed at the sides and therefore have no connection to the surroundings, through which contaminants or microbes could penetrate.

FIG. 1b shows a composite film 20, which corresponds in some regards to the composite film, which is illustrated in FIG. 1a, but in which a less pronounced stretched region 6 has been created in the barrier film before lamination. Because of the slight excess of material in the stretched region 6, no folding 5 has developed in the stress equalization zone 4, so that the stress equalization zone 4 is embodied as a region of a simple lifting of the barrier layer 2 away from the backing layer 1 (and/or the laminating adhesive layer 3). The stress equalization zone 4 also has an excess thickness h based on the total thickness d of the materials of the composite film. This excess thickness h is not constant in general over the course of the stress equalization zone 4 because the stretched region 6 is not pressed against the laminating adhesive layer elsewhere or folding 5 could develop there. Nevertheless, because of the excess material in the stress equalization zone 4 as a whole, there is always a certain excess thickness h. Furthermore, the excess material in the stretched regions also allows effective equalization of stress differences to prevent curling.

The composite film shown in FIG. 1b does not have a sealing film 21, but such a film could easily be provided here as well.

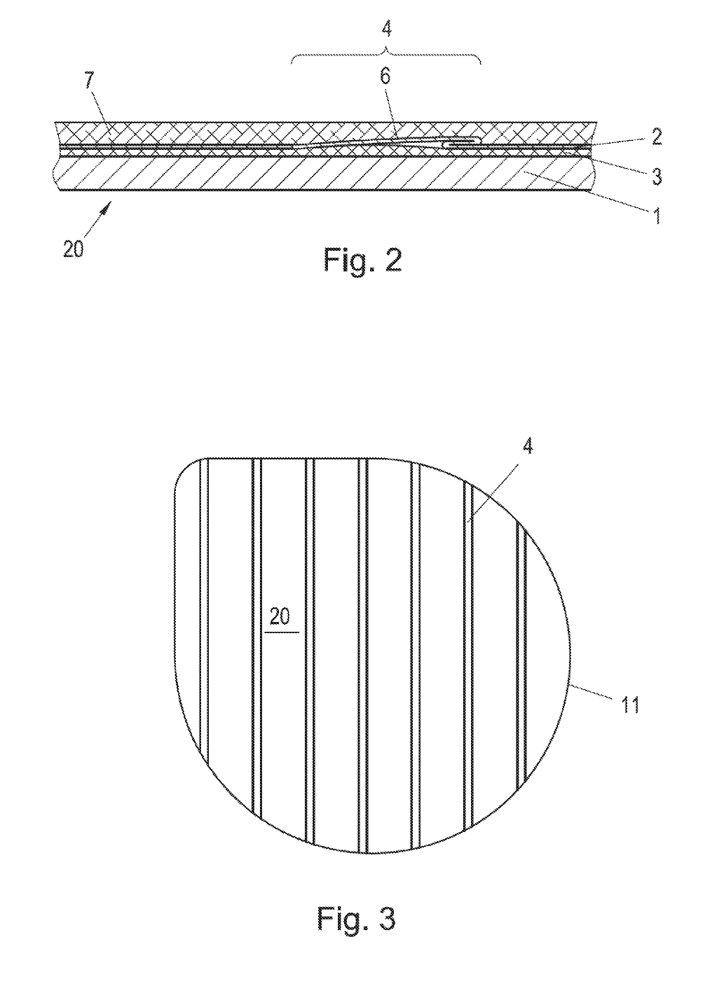

FIG. 2 shows a cross-sectional view of an alternative embodiment of the composite film 20 according to the invention, in which a barrier film without a sealing film 21 has been used as the barrier layer 2. To nevertheless permit sealing of the lid, the composite film 20 is therefore provided with an additional covering layer 7, which is made of a heat-sealing lacquer, which is necessary for special applications. To simplify the illustration, the thickness of the covering layer 7 in FIG. 2 has been illustrated with an exaggerated width. In practice, the covering layer 7 is generally much thinner and, for example, the covering layer 7 may also be thinner than the thickness of the barrier layer 2.

Even if the illustration in FIG. 2 would suggest that the continuous covering layer 7 would destroy the effect of the stress equalization zones 4, the inventors have surprisingly ascertained that the stress equalization zones 4 are nevertheless effective and even in this embodiment completely flat lids which have hardly any or no curling effects can be produced.

FIG. 3 shows a top view of the barrier layer of a lid 11 punched out of a composite film 20 according to the invention, showing several stress equalization zones 4 distributed over the width of the lid. The stress equalization zones 4 are aligned in parallel to the direction in which the lid 11 would curl in the absence of stress equalization zones 4. Therefore the lid 11 will always remain flat even under different weather conditions because the stress equalization zones 4 prevent the occurrence of stresses that would result in bulging. In one exemplary embodiment, the distances between the stress equalization zones 4 and the width of the stress equalization zones 4 can be selected as a function of the properties of the material of the composite film and the layer thicknesses thereof. For example, the stress equalization zones 4 in FIG. 3 may have a spacing of approx. 4 to 10 mm, for example, approx. 6 mm from one another and may have a width of approx. 0.5 to 2 mm, for example, approx. 1 mm.

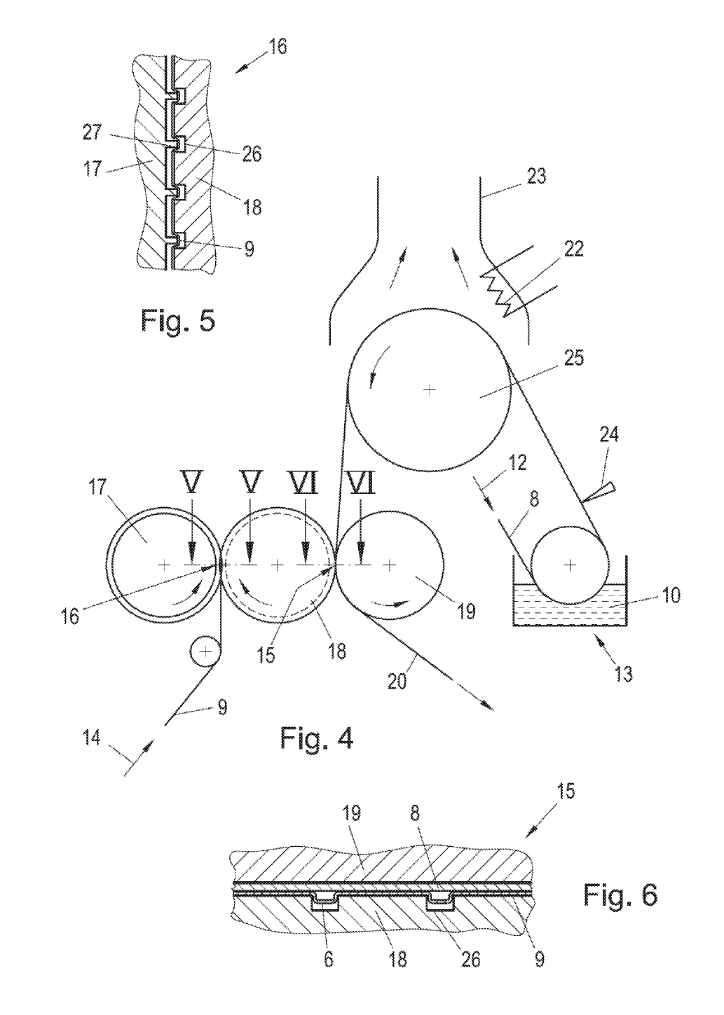

FIG. 4 shows an exemplary embodiment of a device according to the invention for producing the composite film 20 described above. The backing material 8, of which the backing layer 1 of the composite film should consist, is fed through a backing material feed 12, wherein the backing material feed is diagramed schematically as an arrow in FIG. 4. The backing material 8 can be unrolled from a roll or can be fed directly after being printed, so that the device can function as an inline element of the printing device. The backing material 8 is covered with laminating adhesive 10 on one side in a laminating adhesive application system 13, wherein the laminating adhesive layer is leveled using a doctor blade 24. The backing material 8 coated with the laminating adhesive 10 is then sent to a drying roller 25 and dried, while the evaporating solvent is suctioned out through a vent 23. The drying roller 25 itself may be heated. Alternatively or additionally, a heating element 22 or additional heating elements may be provided in order to accelerate the curing of the laminating adhesive 10.

Drying and curing of the laminating adhesive 10 are necessary in particular for dry laminating adhesives, but pretreatment of the laminating adhesive 10 applied to the backing material 8 may also be desirable or necessary before lamination with other types of laminating adhesives.

The backing material 8 coated with the laminating adhesive 10 is then combined with a barrier film 9 and pressed together and bonded to one another in a press device 15, wherein the press device 15 is part of a special roller configuration, consisting of a positive profile roller 17, a negative profile roller 18 and a pressing roller 19, as described in detail below.

The barrier film 9 is fed to the roller configuration by a barrier film feed 14 and is conveyed by the negative profile roller 18 to the press device 15 which is formed by the pressing roller 19 pressing against the negative profile roller 18. The barrier film 9 is preferably supplied at room temperature but it may optionally also be heated or cooled in order to influence the stretching and deformation properties. Cooling may be provided in particular if the barrier film 9 is supplied to the device illustrated in FIG. 4 immediately after (co)extrusion. Before the barrier film 9 reaches the press device 15, it also passes through a stretching entity 16, which is formed by the mutually meshing profiles of the negative profile roller 18 and the positive profile roller 17. The meshing profiles of the two profile rollers 17, 18 are illustrated in the sectional view in FIG. 5.

The negative profile roller 18 has a row of peripheral grooves 26 and the positive profile roller 17 has corresponding peripheral protrusions 27, each engaging in the grooves 26. Between the profiles of the negative profile roller 18 and the positive profile roller 17, there is a sufficient distance everywhere, so that the barrier film 9 stretched between the profiles of the profile rollers 17, 18 in the region of the stretching entity 16 are pressed and stretched by the corresponding protrusion 27 of the positive profile roller 17 into the groove in the region of each groove of the negative profile roller 18 but are not damaged or cut. Thus, a stretched region 6 running longitudinally to the barrier film 9 that is supplied develops in each groove 26. In the region between the grooves 26, where the barrier film 9 is in contact with the outside circumference of the negative profile roller 18, the material of the barrier film 9 is not stretched but instead is merely transported further by the negative profile roller 18.

The partially stretched barrier film 9 is also transported by the negative profile roller 18 by a half revolution and then enters the press device 15 which is formed by the pressing roller 19 pressing against the negative profile roller 18. In the press device 15 the backing material 8 coated with the laminating adhesive 10 and the barrier film 9 conveyed by the negative profile roller 18 are pressed against one another and the barrier film 9 is laminated onto the backing material 8.

FIG. 6 shows a sectional view through the press device 15, i.e., the contact region between the negative profile roller 18 and the pressing roller 19. As can be seen in the sectional view in FIG. 6, the stretched regions 6 of the barrier film 9 are also protected in the grooves 26 of the negative profile roller 18 in the region of the press device 15, so that the barrier film 9 in the stretched regions 6 is not pressed against the backing material 8.

After lamination in the press device 15, the material of the barrier film 9 which protrudes away from the backing material in the stretched regions 6 is in contact with the backing material 8 where it assumes the folded form illustrated in FIGS. 1 and 2. After lamination the composite film 20 is conveyed further for further processing or is rolled up into a roll.

Cavities may remain beneath the stretched regions so that channels running along the stress equalization zones may develop beneath the stretched regions. These channels do not pose any problem in use as a lid because they are compressed in the edge region of the lid during the sealing operation, when a sealing pressure and sealing temperature are applied and they are thereby sealed. It is therefore not generally necessary to “smooth” or compress the cavities remaining against the stretched regions by means of separate devices even if this could be carried out easily as needed.

The design of the stress equalization zones comprised of the stretched regions and the type of folding can be influenced and controlled in particular by means of the relative position between the negative profile roller 18 and the positive profile roller 17, which controls the extent of the stretching, the embodiment of the profiles of these profiles rollers 17, 18 and the contact pressure of the press device.

FIGS. 4 through 6 show a negative profile roller 18 with grooves 26 running along the circumference of the roller in the direction of rotation and accordingly protrusions running around the circumference of the positive profile roller 17 in the direction of rotation, engaging in the grooves 26 in the negative profile roller 18. This results in stress equalization zones 4 which run along the direction of conveyance of the composite film. Alternatively, the stretched regions 6 and/or the stress equalization zones 4 thereby formed but also numerous other patterns may be formed by altering the profile of the profile rollers 17, 18 that are coordinated with one another.

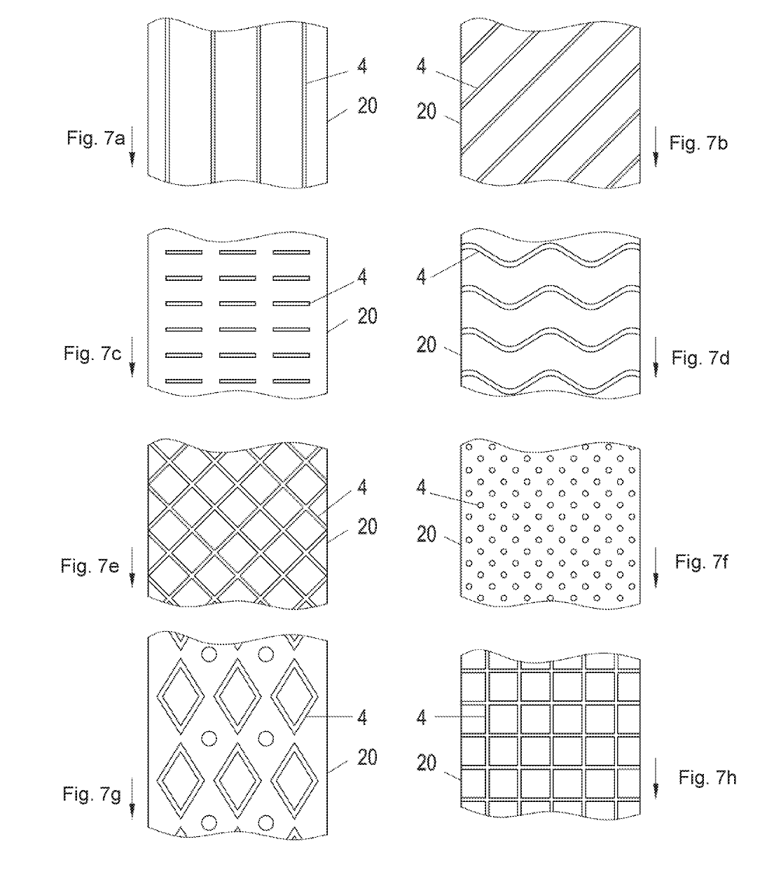

FIGS. 7a to 7h show several alternative patterns that can be achieved with the stretched regions, with an arrow in each case indicating the direction of feed of the composite film during the production process. The patterns are shown merely schematically as an example and are not drawn to scale. The distances between the stress equalization zones 4 can be selected by those skilled in the art optionally with the aid of test strips according to the respective specifications.

FIG. 7a shows the pattern of the stress equalization zones 4 running along the direction of feed, such as those that can be created in a composite film 20 with the aid of the device illustrated in FIGS. 4 through 6.

FIG. 7b shows stress equalization zones 4 running obliquely to the direction of feed.

FIG. 7c shows stress equalization zones 4 running transversely to the direction of feed. The stress equalization zones 4 here are not continuous but instead have interruptions. If necessary the interruptions may also be arranged so they are offset relative to one another or the stress equalization zones 4 could also extend transversely over the entire composite film.

FIG. 7d shows stress equalization zones 4 which extend in a corrugated pattern over the entire composite film. These patterns may also be formed so that they run longitudinally or obliquely or with interruptions.

FIGS. 7e and 7h each show a pattern with intersecting stress equalization zones 4 arranged in the form of a diamond pattern. The pattern in FIG. 7h runs parallel to the direction of feed of the composite film, whereas the pattern in FIG. 7e runs oblique to it.

FIG. 7f shows a pattern in which the stress equalization zones 4 have been reduced to the size of dots. The dots (i.e., circular areas) may be arranged in a regular or irregular pattern or they may optionally be combined with stress equalization zones 4 running longitudinally if the dot pattern does not adequately reduce the curling effects. For example, the separation behavior of the lids can be improved by using the dot-shaped stress equalization zones 4 or the sliding properties and/or frictional properties of the composite film can be influenced. Instead of dots, i.e., circular areas, other decorative shapes such as rectangles, diamonds, rings or stars may also be created.

Similarly patterns made up of geometric polygons could also be created in the barrier film, for example, in the form of a hexagonal pattern as in a honeycomb structure, an octagonal pattern or some other pattern comprises of polygons.

Finally FIG. 7g shows a pattern of stress equalization zones 4 in which the diamond-shaped and dot-shaped stress equalization zones 4 are combined.

The patterns shown in FIGS. 7a to 7h are presented merely as examples and are not drawn to scale and they can be adapted and changed or combined as desired and there are no limits to the design possibilities. Although only regular patterns are illustrated in FIGS. 7a to 7h, the patterns may also be embodied as irregular patterns.

In the production process presented above, the pattern is necessarily repeated with each revolution of the profile rollers. However, the pattern may appear to be completely irregular on a lid produced from the composite film and punched out of it, comprising only a subsection of the overall pattern.

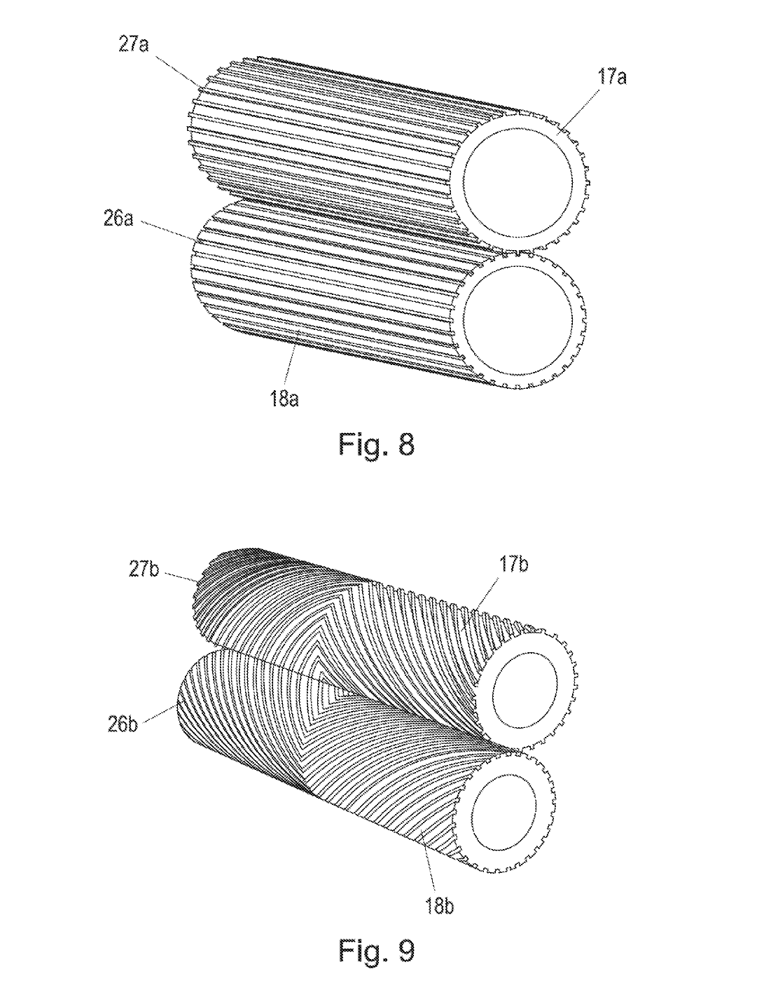

FIGS. 8 through 11 show roller pairs, each consisting of a negative profile roller 18 and a positive profile roller 17, which can be used to produce stretched regions with different patterns.

The profile rollers may preferably each be made of metal, wherein the surface can be hardened to increase the lifetime or may be provided with a surface coating that increases the lifetime. For example, the profile rollers may be provided with a ceramic coating over at least a portion of the surface. In another embodiment, plastic rollers may also be used as the profile rollers. Relatively favorable plastic rollers are advantageous in particular for production of small series or in cases where no major stress on the profile rollers is to be expected. Alternatively, one roller, for example, only the positive profile roller, may be made of metal and the other roller may be made of plastic and embodied as a disposable part, if necessary.

FIG. 8 shows a pair of rollers consisting of a negative profile roller 18a with grooves 26a running transversely to the direction of feed (and parallel to the axis of the roller) and a positive profile roller 17a having corresponding continuous protrusions 27a running parallel to the axis of the positive profile roller 17a. With the help of this roller, even materials that are not readily stretchable can be provided with stretched regions by drawing more film material into the groove 26a in the region of the protrusions 27a than would correspond to the speed of the roller surface. With such a roller, it would also be possible to introduce equalization zones into a material such as paper that has little or no stretchability, such that in this case a stretched region would not represent an actual stretching but instead would constitute a region of essentially unstretched excess material. In conjunction with the present description, such essentially unstretched material excesses would be referred to similarly as stretched regions.

FIG. 9 shows a pair of rollers, consisting of a negative profile roller 18b and a positive profile roller 17b, wherein the profile has grooves 26b and/or protrusions 27b running obliquely to the direction of revolution, and wherein both ends of the profile rollers have different skewed positions. The grooves 26b and/or protrusions 27b meet in the middle of the roller at an angle to one another.

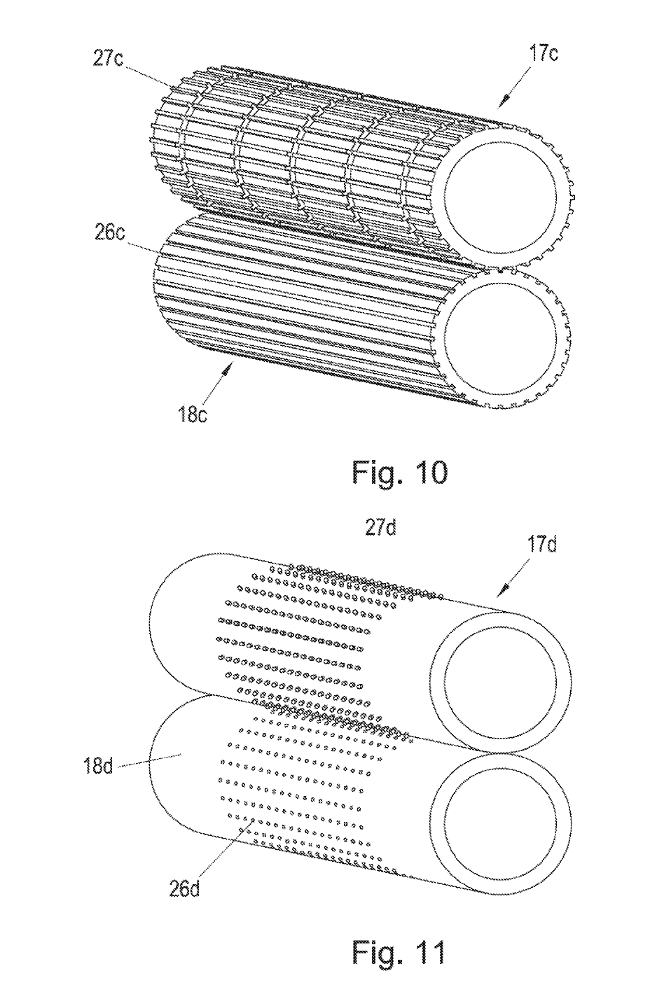

FIG. 10 shows a pair of rollers in which the negative profile roller 18c corresponds essentially to the negative profile roller 18a in FIG. 8, but the positive profile roller 17c has interrupted protrusions 27c. This configuration forms a pattern corresponding essentially to the pattern illustrated in FIG. 7c.

Finally FIG. 11 shows a pair of rollers consisting of a negative profile roller 18d and a positive profile roller 17d with which a dot pattern and/or a circular area pattern can be created in the composite film, corresponding essentially to the pattern in FIG. 7f. The negative profile roller 18d does not have any grooves but it does have circular recesses 26d, which engage with the protrusions, i.e., embossing pins 27d shaped in the form of nubs on the positive profile roller 17d. The diameter of the circular recesses 26d is larger than the diameter of the embossing pins 27d so that the film stretched between the pair of rollers is stretched into the recesses 26d but there remains enough space at the edge of the recess for the barrier film not to be sheared off there. For example, the embossing pins may be cylindrical in shape, so that the end face may bulge outward. The embossing pins may optionally also be embodied as hemispheres or as semi-ellipsoid shapes.

In another embodiment (not shown) instead of the pair of rollers, a vacuum roller which may be in the form of the negative profile roller 18d in FIG. 11, for example, may be used, such that the individual recesses 26d may be acted upon by a vacuum so that the barrier film is drawn into the recesses 26d by the vacuum to create the stretched regions, thereby stretching the film into the recesses 26d. A positive profile roller is not necessary.

Additional roller shapes could also be, for example, a pair of rollers with a combination of a negative profile roller with grooves running longitudinally and recesses arranged between the grooves, for example, circular recesses with a positive profile roller designed accordingly.

In another embodiment, it would also be possible to provide the pair of rollers with a “mixed profile” in which each roller has both positive profile portions and negative profile portions, for example, a roller with both grooves and pins and a corresponding roller with protrusions meshing with the grooves and recesses receiving the pins.

All the examples cited here for roller combinations and stretch patterns are given merely as examples and are not intended to be restrictive in any way. Those skilled in the art are capable of implementing any stretch pattern with the assistance of the teachings of this document without having to make a contribution according to the invention.

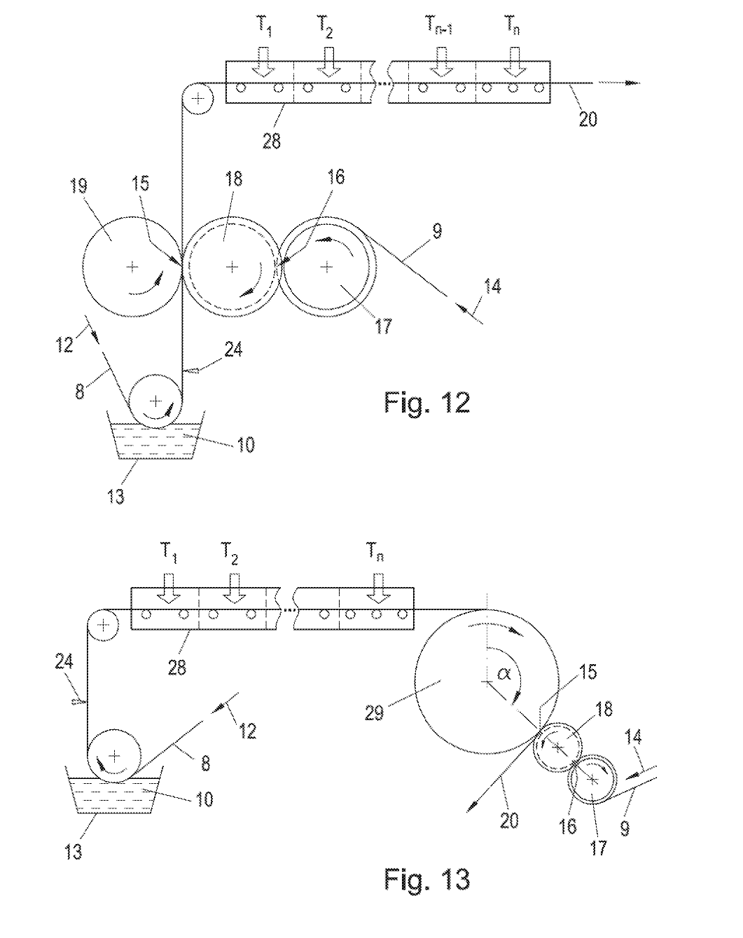

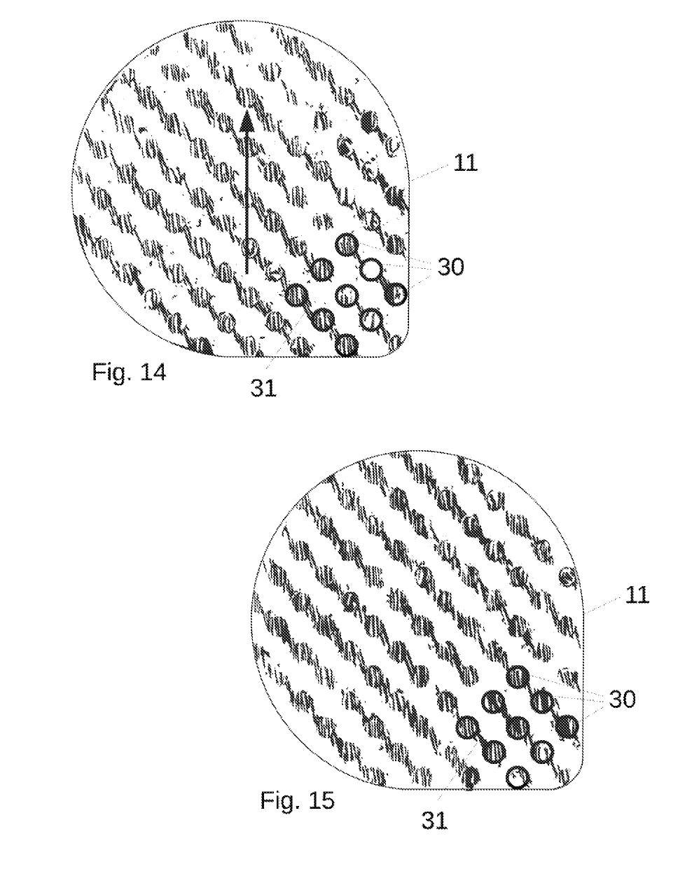

FIGS. 12 and 13 show alternative embodiments of the device according to the invention for producing the composite film 20. Similar elements or those having the same effect are provided with the same reference numerals in FIGS. 4, 5, 6, 12 and 13.

FIG. 12 shows a device for producing a composite film 20, which uses a drying channel 28 with multiple drying zones T1, T2, . . . , Tn for drying the composite material. Immediately after passing through the laminating adhesive application system 13, the backing material 12 wetted with the laminating adhesive 10 is thereby laminated to the barrier film 9 in the press device 15 between the negative profile roller 18 and the pressing roller 19, in which barrier film 9 stretched regions have been previously created by the stretching entity 16 between the negative profile roller 18 and the positive profile roller 17 by a procedure similar to that described above.

The laminated composite film 20 is then dried in the drying channel 28, wherein the drying zones T1, T2, . . . , Tn have different heating stages to ensure a ramp-type heating and cooling of the composite film in the drying channel 28.

This arrangement is suitable in particular for use of wet laminating adhesives, which need not be dried between application and lamination. The solvents of the laminating adhesive 10 evaporate through the backing layer 1 in the drying channel 28. The use of wet laminating adhesives is especially suitable for composite films having a paper backing layer and an aluminum barrier layer. In this case, the solvent evaporates through the paper layer.

FIG. 13 shows another example of an embodiment of the device for producing a composite film 20 which uses a drying channel 28 having multiple drying zones T1, T2, . . . , Tn, but the drying channel in this case is arranged between the laminating adhesive application system 13 and the press device 15. The drying channel 28 thus corresponds in its function essentially to the heating element 22 and/or the drying roller 25 in FIG. 4 and serves to evaporate the solvents of a dry laminating adhesive which is used as laminating adhesive 10.

To improve the lamination process, a cooling roller 29 is provided in the roller arrangement of FIG. 13 instead of the pressing roller 19 from FIG. 4. The backing material 8 coated with the laminating adhesive 10 is guided around a portion of the circumference of the cooling roller 29 and is thereby cooled after passing through the drying channel. The cooling roller 29 has a sufficiently large diameter to cool the backing material 8 coated with the laminating adhesive 10 to an optimum temperature for lamination. In addition, the extent of the cooling can be adapted by varying the angle α at which the negative profile roller 18 is arranged relative to the location where the backing material comes in contact with the cooling roller 29.

FIGS. 14 to 17 show lids which were produced with the help of the same device in several test series, wherein only the infeed setting (i.e. the relative proximity) of the pair of rollers was altered. A roller having a regular arrangement of embossing pins was used as the positive profile roller and a roller having corresponding circular recesses with which the embossing pins of the positive profile roller mesh was used as the negative profile roller. This corresponds essentially to a pair of rollers as illustrated in FIG. 11 as an example. The stretch pattern 30 created by the pair of rollers in the barrier film corresponds to a regular arrangement of deep-drawn circular areas having a diameter of approx. 4 mm, wherein the lateral distance between the circles was also approx. 4 mm each. In several test series, polyester films with a thickness between 8 and 10 μm were laminated onto a backing material made of paper with a thickness of approx. 60 μm. Traditional laminating adhesive systems, preferably dry laminating adhesive systems, were used as the laminating adhesive.

FIGS. 14 to 17 each show a lid 11 made of a composite film according to the invention, produced according to the preceding description. FIG. 14 shows the result of a first series of experiments, in which the setting of the pair of rollers was selected, so that the embossing pins would penetrate only slightly into the circular recesses, such that only a weakly pronounced stretch pattern 30 (a few circles of the stretch pattern are shown with emphasis in the lower right corner of the lid 11 as an example) was intended accordingly. The developers had expected that the elevated pattern 31, which develops during lamination, would essentially correspond to the stretch pattern 30. Surprisingly, however, the elevated pattern 31 was formed not only in the area of the stretch pattern 30 (i.e., at the edges of recesses and/or embossing pins) but was also formed inside the circles of the stretch pattern 30 and also between the circles, so that the elevated pattern essentially formed lines running diagonally to the direction of feed of the barrier film (arrow).

This unexpected result was further investigated by the developers by increasing the infeed setting (i.e. reducing the relative distance) of the pair of rollers incrementally in additional experimental series. FIG. 15 shows a lid 11 with an elevated pattern 31, which results from a slightly increased infeed setting (i.e., increased stretching). It can be seen here that the stretch pattern 30 is only formed weakly in the elevated pattern 31 but is still clearly discernible. The regions of the elevated pattern 31 situated inside and outside the circles of the stretch pattern 30 again form diagonal lines, but the pattern is more irregular, more “frayed” and appears wider than in the example in FIG. 14.

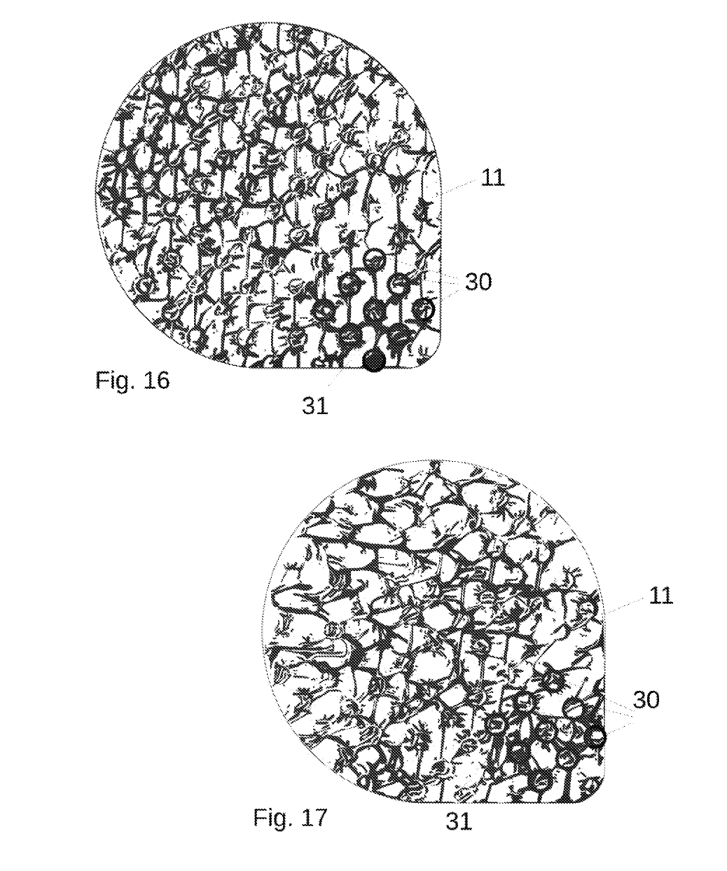

With an even greater infeed setting of the rollers and/or greater stretching, the elevated pattern 31 again changes in a surprising manner: FIG. 16 shows that now an elevated reticulated pattern 31 has formed between the individual circles (still clearly discernible) of the stretch pattern 30, wherein the reticulated pattern extends essentially uniformly over the surface of the composite film. Such a reticulated pattern offers special advantages because a composite film formed in this way can easily be wound onto rolls without resulting in any excess thickness being formed. The lids provided with this pattern have a visually attractive surface structure, while the elevated pattern reliably prevents curling of the lid and the elevated pattern also prevents the pane of glass effect from occurring when the lids are being separated.

When the infeed setting is increased further (FIG. 17), the result is an elevated pattern 31 in which the stretch pattern 30 is less clearly discernible but the elevated pattern 31 has formed a network structure although it is less uniform and is coarser than is the case with the present experimental result depicted in FIG. 16.

Although the exact processes involved in the formation of the respective elevated pattern have not yet been thoroughly investigated, the inventors have arrived at the conclusion that the device according to the invention makes it possible to produce composite films in which the elevated pattern differs more or less from the shape of the stretch pattern created in the barrier film such that only a change in the infeed setting of the pair of rollers can cause a very great change in the shape of the pattern.

Without any restriction of the invention in any way as a result of this theory, it is assumed that even the partially elastic recoil occurring after creation of the stretched regions also plays a role in the development of the elevated pattern. Therefore, the development of the elevated pattern can be influenced not only by the infeed setting of the pair of rollers but also by the circumferential speed, such that this changes the period of time between the creation of the stretch pattern (e.g., by the stretching entity 16 in FIG. 4) and its lamination (e.g., by the press device 15 in FIG. 4). This may result in further changes in the shape of the barrier film (and therefore the elevated pattern) even after lamination.

However, the period of time between the creation of the stretch pattern and lamination can also be influenced easily by a change in the arrangement of the rollers (for example, positive profile roller 17, negative profile roller 18 and pressing roller 19 in FIG. 4), for example, by arranging the rollers in an angular configuration, so that the distance between the stretching entity 16 and the press device 15 and/or the circumferential region of the negative profile roller 18 along which the barrier film 9 with the stretched regions 6 created therein is transported, is increased or decreased. Those skilled in the art can ascertain the best settings to obtain an optimum elevated pattern for each combination of materials by conducting routine experiments and work by adjusting these parameters and other parameters (e.g., temperature, cooling, shape of the stretch pattern, etc.).

In addition to the stretch patterns and roller shapes illustrated as examples in FIGS. 7 through 11, combinations of embossing pins and recesses with other shapes, for example, diamond shapes, star shapes, polygonal, oval or similar shapes may also be used. Rollers with rounded negative and/or positive profiles may be used, for example, when the stretch pattern 30 should not be recognizable at all or should only be slightly recognizable in the elevated pattern 31. Combinations of negative and positive profiles may also be considered in which the negative and positive profiles differ more from one another. For example, circular embossing pins may mesh with groove-type recesses or rectangular, polygonal or oval embossing pins may mesh in circular recesses. The intention is for such combinations of pairs of rollers and similar pairs of rollers and/or the corresponding processes and products produced should also fall within the scope of the claims.

The invention is not limited to the embodiments described above and may be implemented in practice in numerous alternative forms. For example, the laminating adhesive might not be applied to the backing material before lamination but instead could be applied directly to the barrier layer or coextruded with the latter.

1. A composite film having at least one backing layer made of a backing material, at least one barrier layer made of a barrier film and at least one laminating adhesive layer in between, wherein the composite film has an elevated pattern on the side of the barrier layer facing away from the backing layer wherein in the area of the elevated pattern the barrier layer has stretched regions that have been stretched relative to the unstretched barrier film and wherein in the area of the elevated pattern the barrier layer has surfaces on the side facing the backing layer that are not bonded to the backing layer.

2. The composite film according to claim 1, wherein the surfaces which are on the side of the barrier layer, which is facing the backing layer, and which are not bonded to the backing layer, are at least partially in contact with one another.

3. The composite film according to claim 1, wherein the elevated pattern corresponds to a stretch pattern of stretched regions.

4. The composite film according to claim 3, wherein the elevated pattern forms stress equalization zones, which equalize stretching-induced stresses between the layers.

5. The composite film according to claim 4, wherein the stress equalization zones are formed as folds or liftings of the barrier film running along the composite film, which are arranged along the stretch pattern.

6. The composite film according to claim 3, wherein the stretch pattern is a regular or irregular pattern.

7. The composite film according to claim 3, wherein the elevated pattern differs at least partially from the stretch pattern.

8. The composite film according to claim 7, wherein the elevated pattern is a reticulated pattern.

9. The composite film according to claim 1, wherein the elevated pattern has an excess thickness on the surface of the composite film, wherein the ratio of the excess thickness to the total thickness of the individual layers of material in the composite film is less than 10.

10. The composite film according to claim 1, wherein the backing layer is covered with laminating adhesive layer over the full area.

11. The composite film according to claim 1, wherein the composite film has a covering layer.

12. The composite film according to claim 1, wherein the backing layer is printed on the side facing and/or the side away from the barrier layer.

13. The composite film according to claim 1, wherein
the backing material is selected from a fiber material such as paper or cardboard, in particular paper or recycled paper with a thickness between 20 and 120 μm, preferably between 40 and 60 μm; a metal foil, preferably aluminum foil, in particular with a thickness between 5 μm and 30 μm, preferably between 8 μm and 20 μm; or a plastic material such as polyester or some other plastic, in particular with a thickness of 5 to 50 μm, preferably between 12 and 30 μm and especially preferably approx. 23 μm;
the material of the barrier film is selected from polyesters such as polyethylene terephthalate (PET), wherein the polyester film may be provided with an additional surface treatment in the form of metallization or some other inorganic layer, for example, made of SiOx or AlOx or an adhesive layer (primer) for applying a sealing layer; polyamides such as PA 6 or PA 12 or other materials of this group; polyolefins such as polyethylene (PE), ethylene copolymers (EVA, EMA, etc.) or blends of these, polypropylene (PP), PP copolymers or other thermoplastic polyolefins; biopolymers based on renewable raw materials such as starch polymers, polylactic acid (PLA), polymers based on lignin, polyhydroxyalkanoates (PHAs), corresponding blends or compounds, biodegradable/compostable raw materials, such as special biopolyesters; or combinations thereof; and
the laminating adhesive is selected from wet laminating adhesives, dispersion adhesives, dry laminating adhesives, solvent-free laminating adhesives, cold sealing adhesives or extrusion-coated lamination.

14. A lid produced from a composite film according to claim 1 for sealing containers.

15. The lid according to claim 14, wherein sealing to the container the lid has a sealing region on one or both sides of the barrier layer and/or on one or both sides of the backing layer.

16. A device for producing a composite film with at least one backing layer made of a backing material, at least one barrier layer made of a barrier film and at least one laminating adhesive layer in between, wherein the device has a backing material feed, a laminating adhesive application, a barrier film feed and a press device, wherein at least the backing layer, the laminating adhesive layer and the barrier film are pressed at least partially against one another by the press device to laminate them, wherein between the barrier film feed and the press device a stretching entity is provided for introducing a stretch pattern of stretched regions that have been stretched into the barrier film.

17. The device according to claim 16, wherein the stretching entity is formed by intermeshing profiles of a positive profile roller and a negative profile roller between which the barrier film is passed.

18. The device according to claim 17, wherein the press device is designed as a pressing roller which presses against the negative profile roller and between which the material to be pressed to form the composite film is passed.

19. The device according to claim 17, wherein the positive profile roller has a regular or irregular arrangement of elevated embossing pins and the negative profile roller has corresponding recesses with which the embossing pins engage.

20. A method for producing a composite film with at least one backing layer made of a backing material, at least one barrier layer made of a barrier film and at least one laminating adhesive layer in between, characterized in that a stretch pattern of stretched regions is created in the barrier film before lamination, and the barrier film is then laminated as the barrier layer onto the backing layer and that a deformation of the barrier film induced by the stretching and/or partially elastic recoil after stretching creates an elevated pattern on the composite film, wherein in the area of the elevated pattern the barrier layer has surfaces on the side facing the backing layer that are not bonded to the backing layer.

21. The method according to claim 20, wherein the barrier film is guided between a positive profile roller and a negative profile roller with intermeshing profiles to create the stretch pattern.

22. The method according to claim 21, wherein the composite of the backing layer, laminating adhesive layer and barrier layer is pressed between the negative profile roller and a pressing roller.

23. The method according to claim 22, wherein the lamination takes place between the negative profile roller and a pressing roller, wherein the interval of time between embossing and lamination is determined by the radial position of the contact point between the pressing roller and the negative profile roller and the circumferential velocity of these rollers.

24. The method according to claim 20, wherein the elevated pattern differs from the stretch pattern.

25. The method according to claim 24, wherein the development of the elevated pattern is regulated by adjusting the pair of rollers and/or the interval of time between embossing and lamination.

26. The method according to claim 20, wherein the lamination takes place while the barrier layer is undergoing partial elastic recoil after creation of the stretch pattern.
